(19) United States
(12) Patent Application Publication
(10) Pub. No.: US 2020/0224635 A1
(43) Pub. Date: Jul. 16, 2020

(54) Power Generator

(71) Applicant: Formarum Inc., Vaughan (CA)

(72) Inventors: Seyed Nourbakhsh, Vaughan (CA); Mohammad Meshkahaldini, North York (CA)

(21) Appl. No.: 16/602,986

(22) Filed: Jan. 10, 2020

Related U.S. Application Data
(63) Continuation of application No. 16/042,974, filed on Jul. 23, 2018, now abandoned.
Application No. 16/042,974 is a continuation-in-part of application No. 15/503,197, filed on Feb. 10, 2017, now Pat. No. 10,041,177.
(60) Provisional application No. 62/535,768, filed on Jul. 21, 2017.
(60) Provisional application No. 62/182,125, filed on Jun. 19, 2015.
(60) Provisional application No. 62/035,758, filed on Aug. 11, 2014.

(51) Int. Cl. F03B 17/06; H02K 5/18; H02K 7/18; H02K 11/00; C02F 1/461; H02K 9/19; F03B 13/00

(52) U.S. Cl. CPC F03B 17/061; H02K 5/18; H02K 7/1823; H02K 11/0094; C02F 1/46104; F05B 2220/602; F03B 13/00; C02F 2201/46165; F05B 2220/706; F05B 2220/20; F05B 2260/221; H02K 9/19

(57) ABSTRACT

A power generator is provided that in some embodiments includes a tubular generator housing for receiving a fluid flow at an intake end and discharging the fluid flow at an exit end. A generator compartment located within the generator housing contains an electrical generator. The generator compartment includes a plurality of structural members for centrally locating the generator compartment within the generator housing. A thickness of a thermally conductive outer wall of the generator compartment tapers from a thickest portion in front of the electrical generator to a thinnest portion adjacent to the electrical generator.

### CROSS-REFERENCE TO RELATED APPLICATIONS

This application claims the benefit of U.S. Provisional Application No. 62/535,768, filed on Jul. 21, 2017, the contents of which are incorporated herein by reference. This application is also a continuation-in-part of U.S. Utility application Ser. No. 15/503,197, filed on Feb. 10, 2017, which is a Section 371(c) national stage of Patent Cooperation Treaty Patent Application No. PCT/CA2015/000457, filed on Aug. 7, 2015, which claims the benefit of U.S. Provisional Application No. 62/182,125, filed Jun. 19, 2015, and which also claims the benefit of U.S. Provisional Application No. 62/035,758, filed Aug. 11, 2014, the contents of all of which are incorporated herein by reference.

### FIELD

The present application pertains to the field of power generators. In particular, this application pertains to a power generator that extracts a portion of energy from a fluid path to power a device.

### BACKGROUND

Power generators are electrical power generators that are used in a wide variety of applications to extract energy from a fluid flow travelling through a fluid path. Typically, power generators are used to generate electricity from the fluid flow and the goal is to extract the maximum possible energy from the fluid flow.

Examples of these types of applications include hydro-electric dams which dam up a supply of water in a reservoir to create a supply of water in a high energy state. The reservoir water is input into an intake to a penstock which directs a flow of water under pressure to a turbine which is rotated by the flow of water to generate electricity. The spent flow of water is directed to an outflow river in a much lower energy state (e.g. lower pressure and flow rate) from the intake water. The typical goal in this type of application is to derive as much energy as possible from the flow of water in the penstock and accordingly the turbine is designed with this goal in mind. Since water is the most common fluid used in these applications the systems are referred to as “power generators”, but in principle the systems could be applied to any fluid flow.

In many applications it is useful to have a local supply of energy for operation of a device without having to run a dedicated power supply line to the device location. In the case of applications that include a fluid travelling through a fluid path in some cases it would be useful to extract from the fluid flow the minimum energy required for the device, lowering the energy state of the fluid flow as little as possible. Unlike conventional generation systems, in these applications the goal is to extract the minimum possible energy from the fluid flow in order to power the device. As a result, the efficiency of the power generator is considered based on minimising resistance to the fluid flow, while still extracting sufficient energy to supply the local device needs.

Therefore there is a need for a power generator that is not subject to one or more limitations of the prior art.

This background information is provided to reveal information believed by the applicant to be of possible relevance to the present application. No admission is necessarily intended, nor should be construed, that any of the preceding information constitutes prior art against the present application.

### SUMMARY

In embodiments the present application is directed toward a power generator that includes an electronic control system, a generator, and a generator arranged in linear alignment with the fluid flow.

In some embodiments, a power generator is provided. The power generator including: a tubular generator housing for receiving a fluid flow at an intake end and discharging the fluid flow at an exit end; a generator compartment located within the generator housing, the generator compartment containing an electrical generator; and, the generator compartment including a plurality of structural members for centrally locating the generator compartment within the generator housing; wherein a thickness of a thermally conductive outer wall of the generator compartment tapers from a thickest portion in front of the electrical generator to a thinnest portion adjacent to the electrical generator.

In some implementations, the structural members are streamlined.

In some implementations the thermally conductive wall further thickens after the electrical generator.

In some implementations the structural members are supported by the thickest portion of the thermally conductive outer wall.

In some embodiments, of a power generator, a control assembly is provided. The control assembly including a diverter to divert a portion of a fluid flow travelling along a fluid path into a cooling cavity to receive thermal heat from control electronics of the control assembly. An exit from the cooling cavity located to direct the cooling fluid back into the fluid flow. In some implementations the fluid flow is directed past the control assembly to a rotatable member of the power generator. In some implementations an electrical generator is located between the control assembly and the rotatable member. In some implementations an outer wall of a compartment housing the electrical generator is in contact with the fluid flow and thermally transfers heat generated from the electrical generator to the fluid flow.

In some embodiments of power generator, a plurality of enclosed fluid channels are provided to direct a flow of fluid form a flow path generally parallel to an axis of rotation of a rotatable member of the power generator to an inward flow path at generally perpendicular to the axis of rotation. In some implementations, a wall of the enclosed fluid channels is defined by a wall of a generator compartment housing an electrical generator mechanically connected to the rotatable member.

### BRIEF DESCRIPTION OF THE FIGURES

Further features and advantages will become apparent from the following detailed description, taken in combination with the appended drawings, in which:

FIG. 1 illustrates end and cross-section views of embodiments of an inlet cap.

FIGS. 2 and 3 illustrate embodiments of a generator compartment for location within an electrical generator housing.

FIGS. 4 and 5 are views illustrating a generator compartment within an electrical generator housing and including a rotatable member and enclosed fluid channels.

FIG. 6 are views of an end cap for mating with the electrical generator housing and directing fluid flows to a rotatable member.

FIGS. 7 and 8 illustrate embodiments of an electrochemical treatment module for connection to embodiments.

FIGS. 9A and 9B illustrate alternate embodiments of FIG. 1 that include a diverter for diverting a portion of the fluid path into a cooling cavity.

FIGS. 10A to 10F illustrate alternate embodiments.

It will be noted that throughout the appended drawings, like features are identified by like reference numerals.

### DETAILED DESCRIPTION

The Figures of this application illustrate elements of an assembly that may be combined to provide a water treatment device that incorporates a power generator and a control module located in an inlet cap of the water treatment device. An example of such a modular water treatment device may be found, for instance, in PCT/CA2015/00457 (U.S. Pat. No. 15/503,197) in which modular components including a control assembly, an electrical generator, a turbine, and an electrolytic treatment module may be assembled to form a water treatment device, all of which is incorporated herein by reference. The Figures of the present application describe improvements in the context of modular components of such a water treatment device, but are applicable generally to power generators that extract a portion of energy from a fluid flow to power a local device.

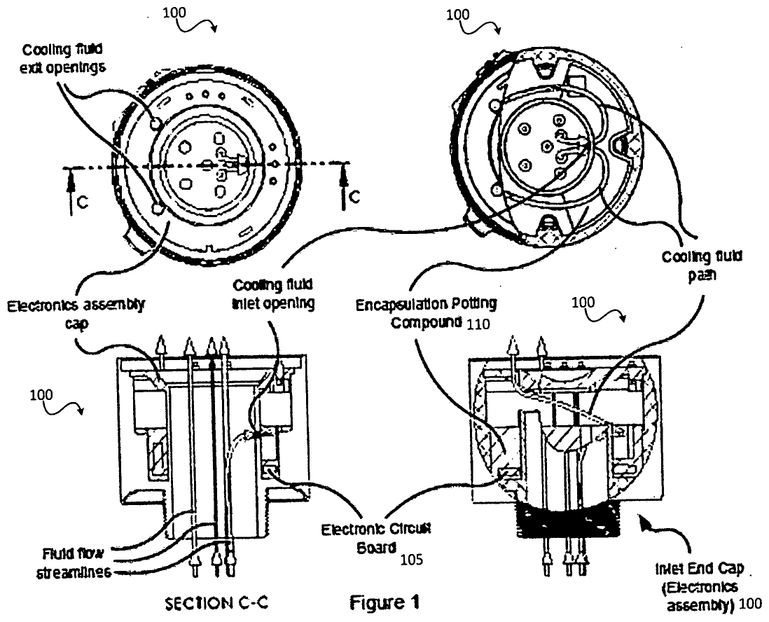

FIG. 1 shows multiple views of an inlet end cap 100 of the power generator, containing the electronic control system, demonstrating how a portion of a fluid flow entering the power generator may be diverted from the bulk of the fluid flow through one or more inlet openings and directed to enter a cooling cavity for cooling the proximately located control system which may include, for instance, an electronic circuit board 105. The diverted portion of the fluid flow acts as a cooling fluid to remove the heat generated by the control system (e.g. the electrical circuits of the electronic circuit board 105. In the embodiment, as illustrated a thin layer of thermally conductive potting compound 110 is used to encapsulate the electronic circuit board 105 to isolate and protect the electronic circuit board 105 from the diverted portion of the fluid flow. Heat generated by the electronic circuit board 105 may be conducted through the thermally conductive potting compound 110 for thermal transfer to the diverted portion of the fluid flow and conveyed from the cavity back to the bulk fluid flow.

In the embodiment of FIG. 1, the cooling fluid is directed to circulate through the cavity, receive thermal transfer of heat from the wall of encapsulation potting compound 110, and removing the received heat from the wall, before exiting through one or more exit openings implemented in the inlet end cap 100, opposite to the inlet opening used to allow the cooling fluid to enter the cavity. The exiting cooling fluid rejoins the bulk of the fluid flow entering the power generator. In some embodiments one or more of the exit openings may be located inline with the one or more inlet openings. In some embodiments the one or more exit openings may be located downstream from the one or more inlet openings.

In some embodiments the intake to the cavity may be downstream from the cavity, and the fluid may be directed upstream to the cavity for receiving thermal transfer of heat generated by the electronic circuit board 105 before exiting downstream from the cavity into the bulk fluid flow. In other embodiments, the intake to the cavity may be inline with the fluid flow and the diverted portion of the fluid flow may flow substantially inline with the fluid flow, rather than travelling upstream form the intake to receive thermal transfer from the potting compound 110.

Referring to the side views of FIG. 1, the input fluid to the power generator is diverted from the bulk fluid flow as cooling fluid through one or more inlet openings. The one or more inlet openings fluidly connected to a cooling chamber adjacent to an end wall of an electronic control system compartment housed in the inlet end cap 100. The thermally conductive potting compound 105 encapsulating the electronics (e.g. electronic circuit board 105) and defining an end wall of the cooling chamber. The thermally conductive potting compound 105 acting as a physical barrier to separate the circulating cooling fluid in the cooling chamber from the electronic circuit board 105 in the electronic control system compartment and to conduct heat generated by the electronic circuit board 105 in the electronic control system compartment to the circulating cooling fluid.

As indicated in the end section views, the circulating cooling fluid is directed through the cooling fluid inlet opening(s) into the cooling chamber for circulation about and in contact with the thermally conductive potting compound 105 before exiting through one or more cooling fluid exit openings to rejoin the bulk fluid flow through the power generator. Accordingly, the cooling fluid receives thermal energy generated by the electronic control system and conveys the thermal energy out of the electronic control system compartment when as it travels through the cooling fluid exit openings to rejoin the fluid flow path.

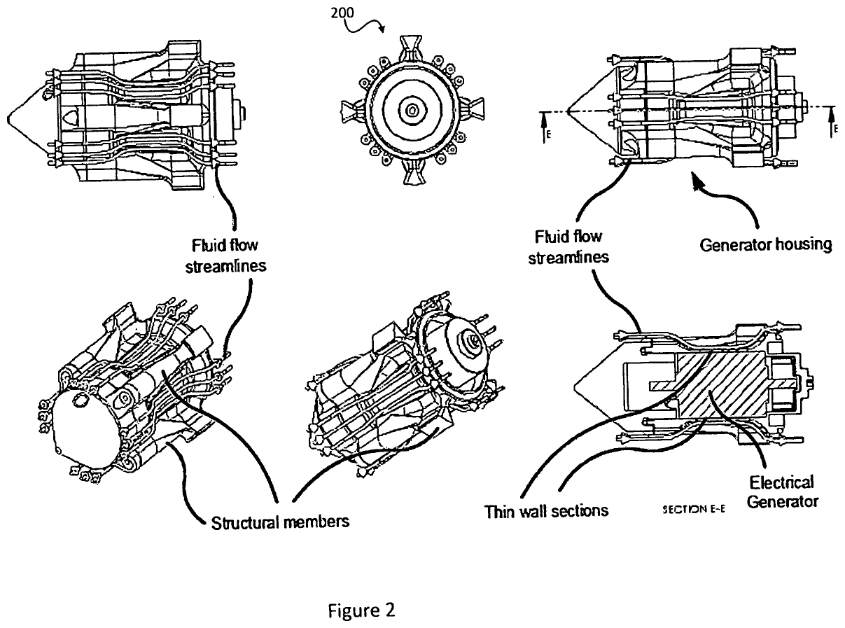

FIG. 2 shows multiple views of an electrical generator compartment that may be located in an electrical generator housing. The electrical generator compartment containing an electrical generator operative to generate electrical energy when an input drive shaft is rotated. In the present example, the electrical generator drive shaft is rotated by a turbine, not visible in FIG. 2. The improvements of FIG. 2 are the inclusion of streamlined structural members which locate the electrical generator within the fluid flow. The structural members located to rigidly fix the electrical generator within the electrical generator housing, but allow the fluid flow to smoothly pass around the electrical generator. The compartment housing the electrical generator including thin thermally conductive wall sections to physically separate the electrical generator from the fluid flow, and to allow the conduction of thermal heat from the electrical generator to the fluid flow.

Accordingly, the electrical generator compartment of FIG. 2 includes features designed to remove the heat generated by the electrical generator, and to direct the fluid flow over the thin wall sections of the generator compartment to maximize heat removal from the electrical generator. In the illustrated embodiment of FIG. 2, the multiple structural members ensure that the structural strength is not compromised by the thin wall sections of the generator compartment, in addition to fixing the generator position centrally within the electrical generator housing of the device.

In an embodiment, the wall of the generator compartment is gradually thinned to a thinnest wall section around the electrical generator itself, where maximum heat is generated, and gradually widened as the fluid departs the generator housing. The gradual decrease and increase in the wall thickness about the electrical generator acts to ensure that the cooling fluid flow is not separated from the wall of the generator compartment, resulting in maximum heat transfer from the thin portion of the generator compartment wall to the fluid flow. This arrangement assists in removal of heat from the generator during operation and transference to the fluid travelling through the fluid flow path through the generator housing and around the generator compartment that contains the electrical generator.

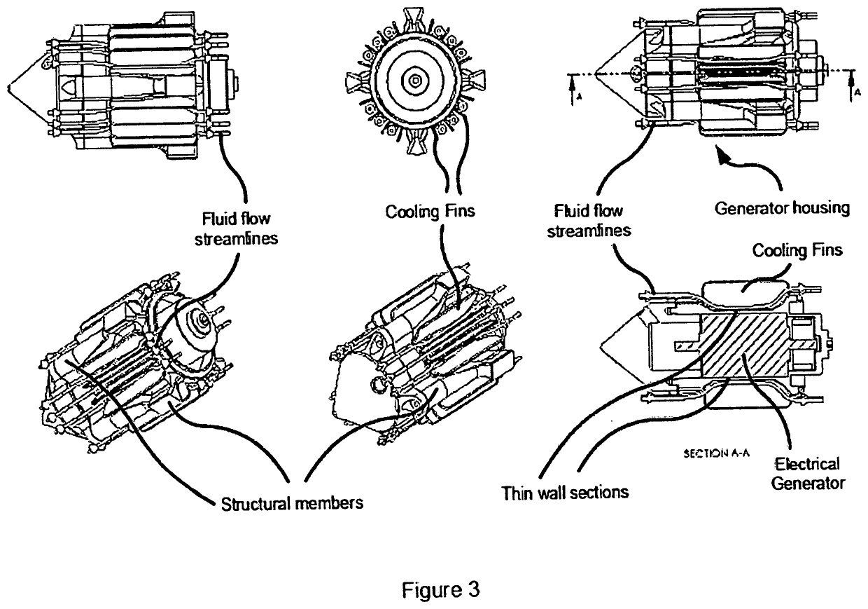

FIG. 3 show multiple views of another embodiment of the electrical generator compartment, with cooling fins added to the thin wall sections of the generator compartment for improved cooling of the electrical generator. Due to the design of the electrical generator housing, the fluid travelling through the device along the fluid flow path travels around the electrical generator compartment, receives thermal energy from the outer wall of the generator compartment, including the cooling fins, and conveys the thermal energy away from the electrical generator housing.

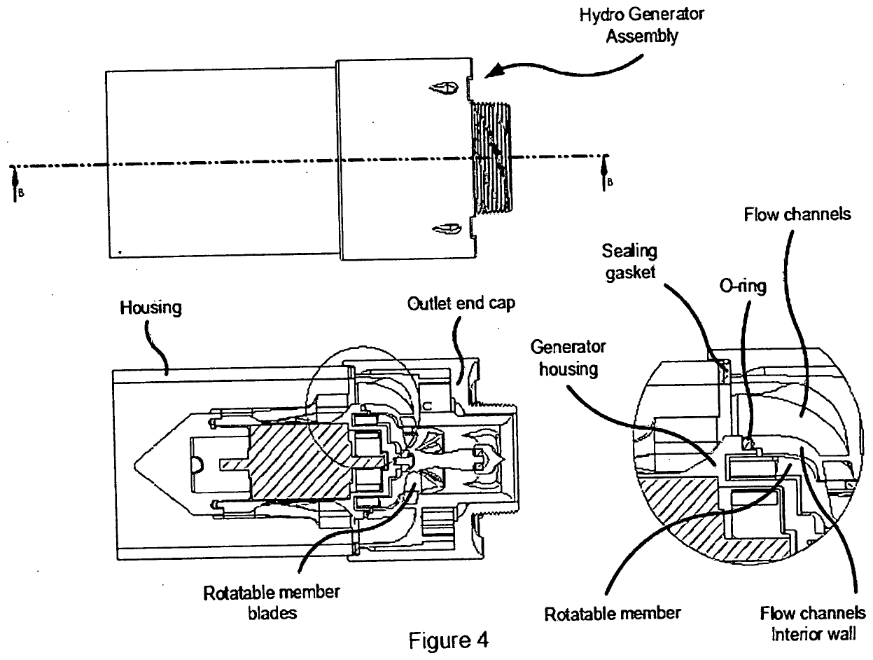

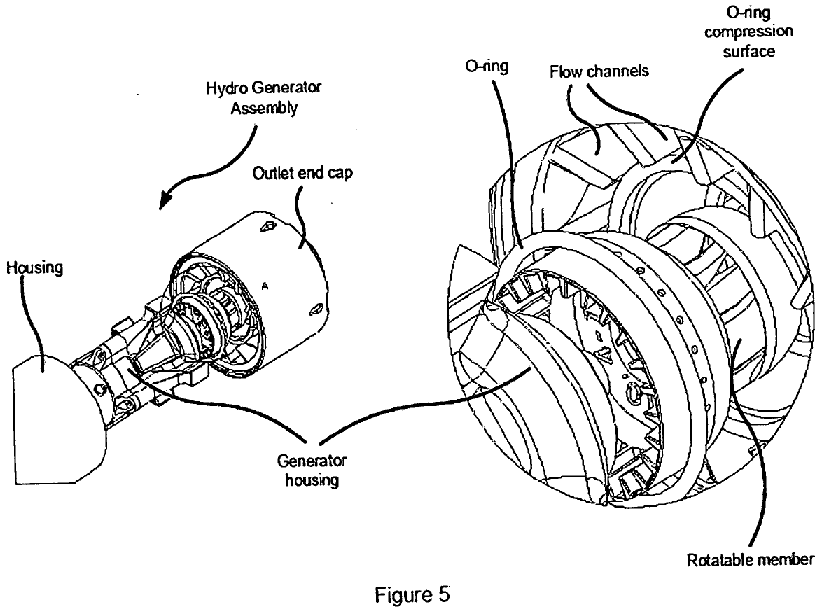

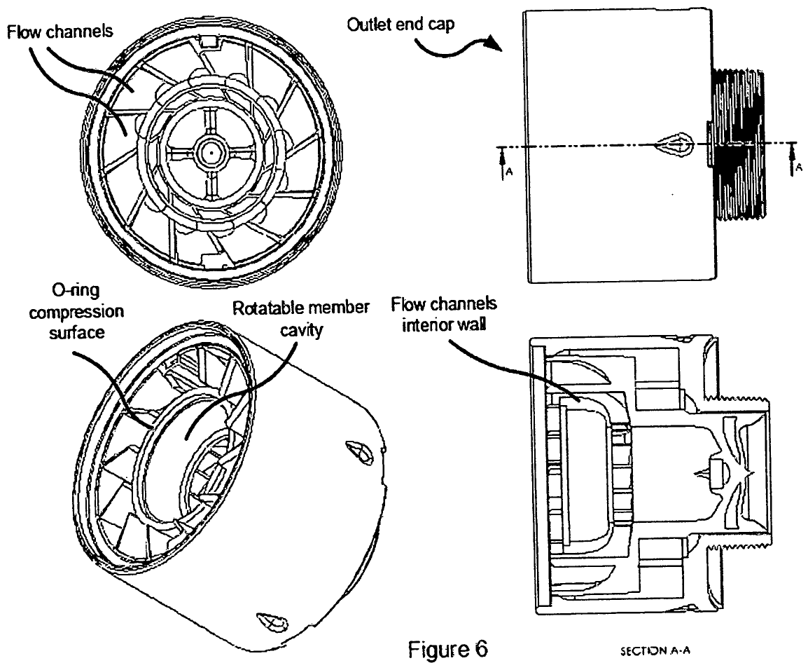

FIGS. 4, 5, and 6 show multiple views of an electrical generator compartment located within an electrical generator housing, with improvements made to the design of the mechanical guide features, generator compartment, and rotatable member (e.g. turbine) to ensure the entirety of the fluid flow is directed and accelerated by the mechanical guide features through defined flow channels. These improvements prevent undesired stray flow from entering the clearance between the rotatable member and the mechanical guide features. The improvements increase the hydro generator efficiency by eliminating the stray flow leak that would not otherwise directly enter the rotatable member blades at right angles to their axis of rotation and therefore do not fully contribute to power generation.

The improvements are achieved by adding an interior wall to the mechanical guide features, creating defined flow channels. In previous versions of power generators developed by the inventors mechanical guide features in the form of vanes located in an end cap of the device were used to re-direct the fluid flow from a flow path generally parallel to the axis of rotation of the rotatable member to an inward flow that is tangential to the rotation of the rotatable member and generally perpendicular to the axis of rotation of the rotatable member. On leaving the rotatable member the fluid flow path is once again generally parallel to the axis of rotation.

In the present application the vanes are replaced with enclosed fluid channels, each defining an enclosed fluid channel that end in outlets ports at a periphery of the rotatable member. In this fashion, the fluid flow is diverted from a generally parallel flow to a plurality of inwardly directed flows about a circumference of the rotatable member. Each of the plurality of inwardly directed flows directed at a tangent to the rotation of the rotatable member. By constraining each of the plurality of inward fluid flows within separately contained fluid channels the fluid is less able to backflow up the fluid path when it is directed at the rotatable member. The improvement reduces the amount of energy extracted from the fluid flow as it transitions from a parallel path to an inward perpendicular path and back to a parallel path at the exit from the rotatable member.

In an embodiment, the defined flow channels each comprise an enclosed flow port directing fluid at the rotatable member (e.g. a turbine runner). In some embodiments, the interior wall of the flow channels may be formed with the mechanical guide features as an integral solid component with fluid flow channels formed through the bulk of the component.

In some embodiments, the interior wall of the flow channels may comprise a separate component fastened to the mechanical guide features to define the enclosed flow channels. Conveniently, the interior wall completing the enclosed flow channels defined by the mechanical guide features may comprise an outer wall of the generator compartment of the electrical generator assembly.

In some embodiments, as illustrated in FIG. 4, an O-ring may be compressed between the flow channels' interior wall and a groove on the generator housing, effectively preventing any stray flow from entering the rotatable member cavity.

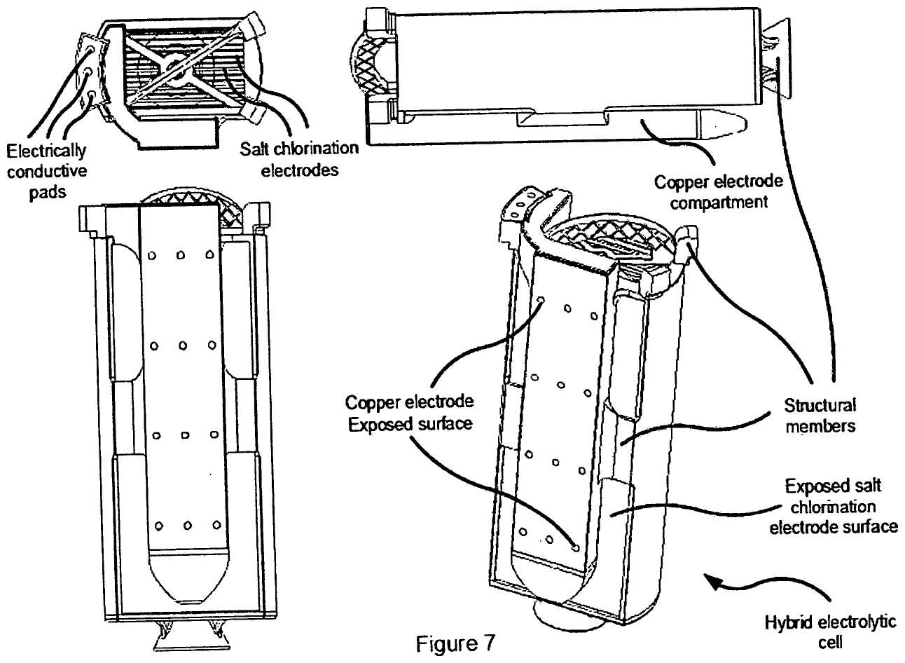

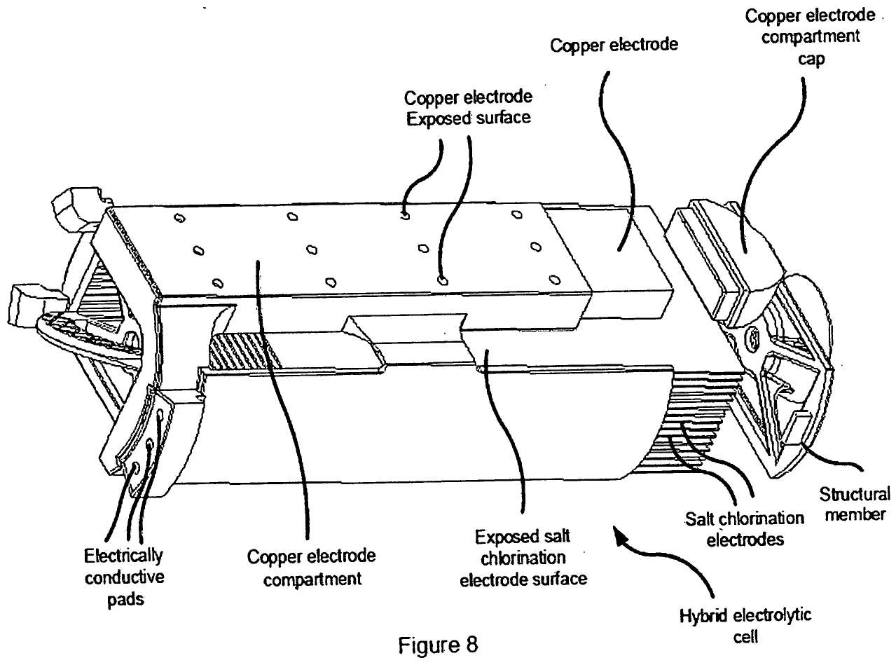

In embodiments where the power generator forms part of a water treatment device, FIG. 7 and FIG. 8 show multiple views of a hybrid electrolytic cell, with mechanical features added to control the rate of production of metallic ions, and prevent the sacrificial metal electrode from structurally disintegrating in the device.

A non-conductive electrode compartment is designed for the sacrificial metal electrode, located adjacent to one of the chlorine producing electrodes, with a gap allowing fluid flow between the two. There are one or more openings, of determined size and location, on the sacrificial metal electrode compartment, exposing the surface of the sacrificial metal electrode to the flow. The openings can be on the surface facing the chlorine producing electrode, its opposite side, the side walls of the sacrificial metal electrode compartment or a combination of these surfaces. The rate of production of metallic ions can be controlled by the amount of surface area of the sacrificial metal electrode exposed to the flow and the distance created between the exposed surface of the sacrificial metal electrode and the chlorine producing electrode, based on the position of the openings. A desired rate of production of metallic ions can be achieved by passing fluid with conductivity characteristics similar to the design operating points and varying the size, number, and position of the openings on the sacrificial metal electrode compartment, until the desired electrical current, corresponding to the desired production rate, is reached.

The sacrificial metal electrode compartment has the additional benefit of structurally supporting the sacrificial electrode, ensuring it does not disintegrate within the device as the electrode approaches its design useful life, preventing disintegrated debris from entering the hydro generator assembly which could cause reduce efficiency or damage.

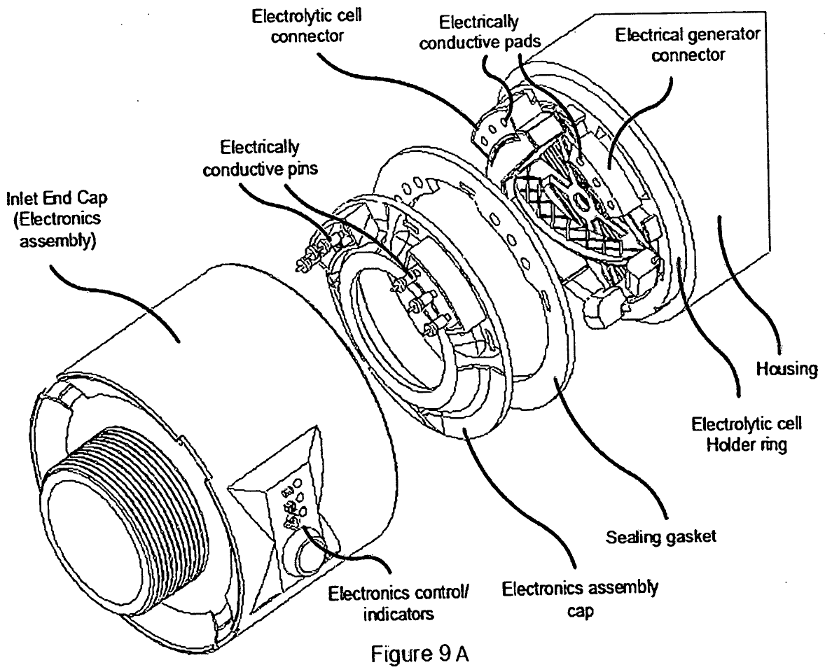

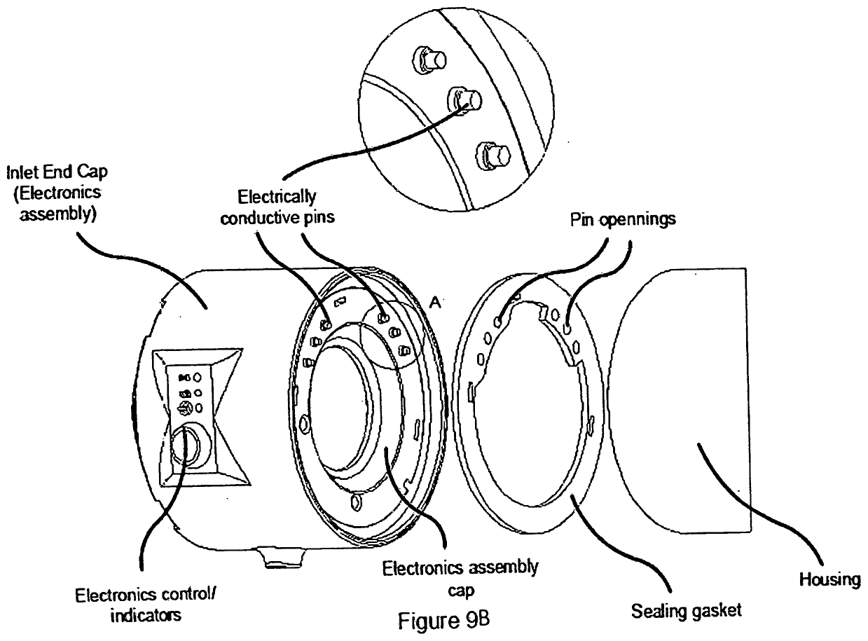

FIGS. 9A and 9B show multiple exploded and assembled views of the modular electrical connections between the inlet end cap containing the electronic control system, the hybrid electrolytic cell, and the electrical generator.

Electrically conductive pins, which may be of a spring-loaded type design, may be permanently electrically connected to the electronic circuit board, using electrical wires. Electronic encapsulating potting compound, such as the thermally conductive potting compound described above, may then be used to seal the electronic circuit board within the inlet end cap. Electrically conductive pins can then be inserted into cavities within the electronic assembly cap and sealed on the side facing the inlet end cap using the encapsulating compound, securing their position and sealing the electrical connection to the electronic circuit board.

The electrical generator and selected electrolytic cell electrodes can be permanently connected, using electrical wires, to connectors exposing electrically conductive pads. The electrical generator connector may be inserted directly into the electrolytic cell holder ring while the electrolytic cell connector may from part of the modular electrolytic cell assembly, which may then be inserted into the electrolytic cell holder ring

As the device is assembled, a sealing gasket of pre-determined design is compressed between the electronic assembly cap and the housing, electrolytic cell holder ring, the electrolytic cell, and the connectors, simultaneously sealing the device from the exterior environment and creating sealed chambers where the electrically conductive pins and pads come into contact, automatically establishing electrical pathways between the electrical generator, the electronic circuit board, and the electrolytic cell.

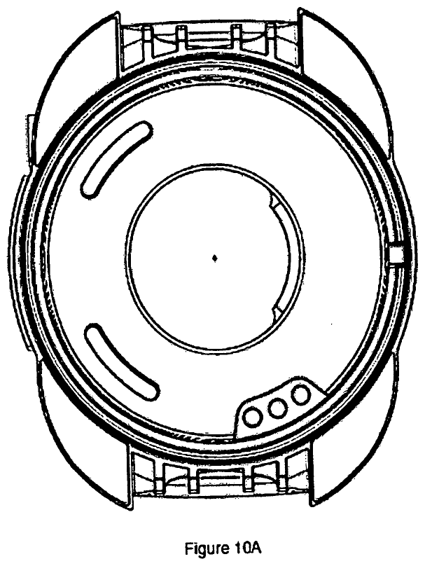

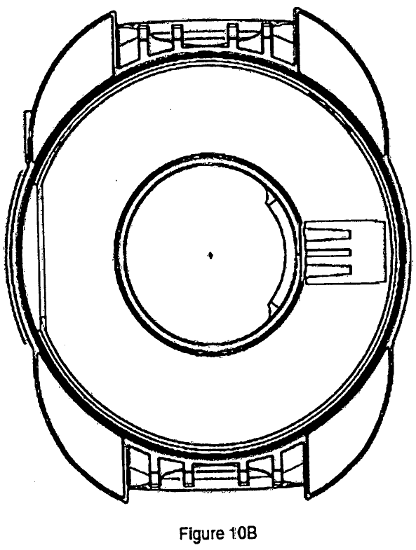

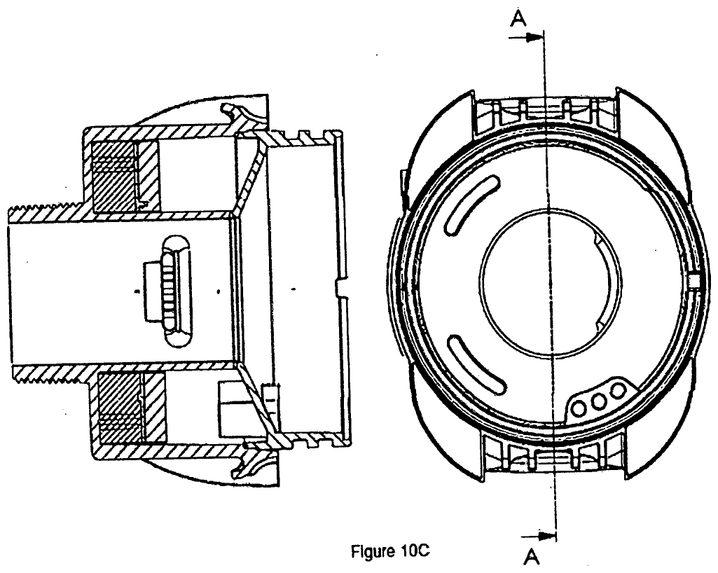

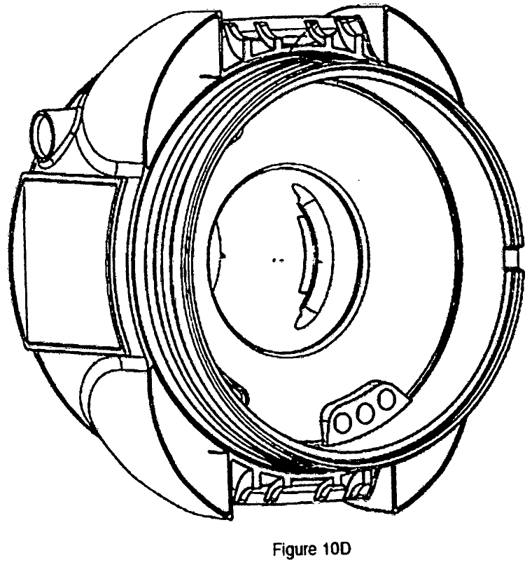

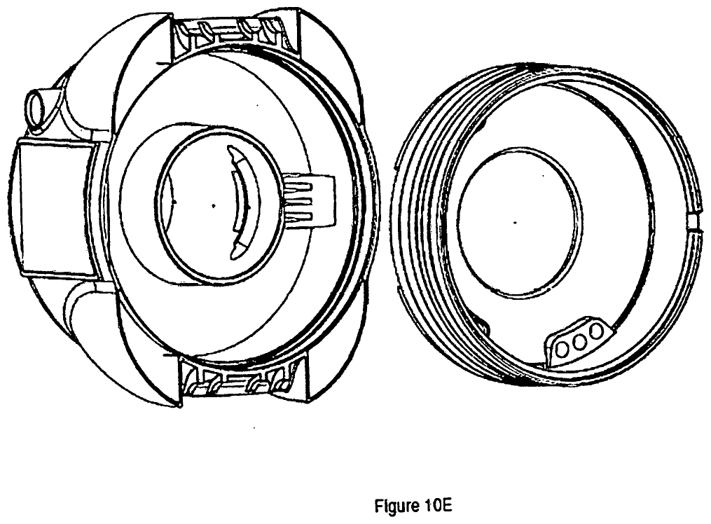

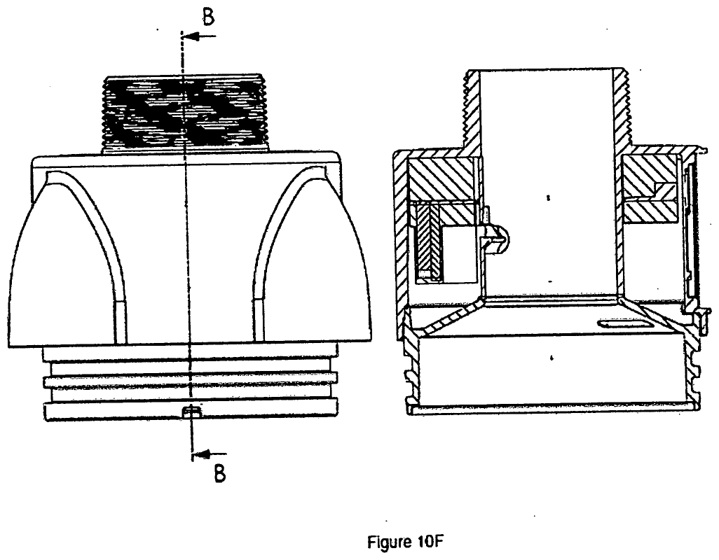

FIGS. 10A-10F illustrate an alternate embodiment of the inlet end cap of FIG. 1. In particular, the alternate embodiment includes a diverter that intrudes into the fluid flow path to divert a portion of the fluid flow. The diverted fluid flow comprising cooling fluid to be circulated through the inlet end cap and to receive and convey thermal energy from the inlet end cap. In the embodiment of FIG. 1, the thermal energy is produced by the electronic control system housed in the inlet end cap through the end wall of the cooling chamber.

In the embodiment of FIGS. 10A-10F, the thermal energy is further produced by a resistor comprising a dummy load. The resistor in selective electrical communication with the generator of the power generator. In an embodiment, as illustrated in FIG. B, the resistor is in thermal communication with a heat sink. The heat sink may be located in the fluid path, or, as illustrated in FIG. 10B, the heat sink may be conveniently located in the cooling chamber. To assist with the heat transfer form the resistor, the heat sink may be located proximate to the inlet port or the outlet port of the cooling chamber to provide fluid flow over the heat sink. In the embodiment of FIG. 10b, the heat sink is located over the inlet port, such that cooling fluid enters the cooling chamber by flowing past the fins of the heat sink.

The purpose of the dummy load provided by the resistor is to receive excess energy produced by the power generator. Since the power generator is driven by a fluid flow, during times when full power is not required the excess energy may be diverted to the resistor acting as a dummy load. This arrangement avoids the need to “free-wheel” the power generator during low power demand periods. Free-wheeling may lead to excess turbine runner rotational speeds and reduced power generator operating life due to such excessive speeds. In an embodiment, the electronic control system may be operative to selectively electrically connect the dummy load resistor to the generation circuit of the power generator when the electronic control system has determined that the power production of the power generator is not required for the main load. In an embodiment, for instance, the main load may comprise an electrolytic cell for providing water treatment products to fluid flowing through the fluid flow path. The electronic control system may be operative to selectively energize the electrolytic cell based on operational requirements, such as, for instance, a measurement of a product concentration in the fluid flow path, a receiving reservoir, or a predicted concentration of the product determined by the electronic control system. Regardless of the control reason for de-energizing the load, such as the electrolytic cell, the electronic control system may, in an embodiment, be operative to redirect the electrical output of the power generator to the dummy load resistor by selectively electrically decoupling a load electrical circuit from the power generator electrical output, and electrically coupling the dummy load resistor to the power generator electrical output. Once connected, the dummy load resistor receives the electrical output from the power generator and converts the received electrical output to heat. The heat sink in thermal communication with the dummy load resistor receives the generated heat and transfers it to the cooling fluid travelling through the cooling chamber.

FIGS. 10C and 10D are illustrations of the inlet end cap including outlet ports in a cap ring of the cooling chamber to receive the cooling fluid that has passed through the cooling chamber and to re-integrate the received cooling fluid into the fluid flow path. In the embodiment, a cap ring is secured in an end of the inlet end cap to define a wall of the cooling chamber. Slots in the cap ring provide outlet ports for egress of the cooling fluid to be re-integrated with the fluid flow path as the fluid is diverted around the electrical generator of the power generator.

FIG. 10E is an exploded isometric view of the inlet end cap of FIG. 10D showing the cap ring separated from the rest of the inlet end cap. In the embodiment of FIG. 10E, the cap ring and the rest of the inlet end cap include cooperating threads to secure the cap ring in place over the rest of the inlet end cap to define the cooling chamber. The outlet ports comprise slots in the cap ring of FIG. 10E. In an embodiment, the slots are located at an opposite side of the cooling chamber from the inlet ports when the cap ring is seated and secured on the rest of the inlet end cap.

FIG. 10F is a side view of the inlet end cap with the cap ring secured in place.

Although the present application describes specific features and embodiments, it is evident that various modifications and combinations can be made thereto without departing from the invention. The specification and drawings are, accordingly, to be regarded simply as an illustration as defined by the appended claims, and are contemplated to cover any and all modifications, variations, combinations or equivalents that fall within the scope of those claims.

1. A power generator comprising:
a tubular generator housing for receiving a fluid flow at an intake end and discharging the fluid flow at an exit end;
a generator compartment located within the generator housing, the generator compartment containing an electrical generator; and,
the generator compartment including a plurality of structural members for centrally locating the generator compartment within the generator housing
wherein a thickness of a thermally conductive outer wall of the generator compartment tapers from a thickest portion in front of the electrical generator to a thinnest portion adjacent to the electrical generator.

2. The power generator of claim 1, wherein the structural members are streamlined.

3. The power generator of claim 1, wherein the thermal conductive wall further thickens after the electrical generator.

4. The power generator of claim 1, wherein the structural members are supported by the thickest portion of the thermally conductive outer wall.

5. A power generator comprising:
(a) an inlet end cap comprising (i) at least one cooling fluid inlet opening, (ii) at least one cooling fluid exit opening, (iii) an electronic control system comprising an electronic circuit board, and (iv) thermally-conductive potting material encapsulating the electronic circuit board; and
(b) an electrical generator housing comprising an electrical generator compartment (i) containing an electrical generator and streamlined structural members configured to rigidly fix the electrical generator within a flow of fluid in the electrical generator housing and (ii) comprising a wall of non-uniform thickness.
